(19) United States
(12) Patent Application Publication
(10) Pub. No.: US 2005/0171815 A1
(43) Pub. Date: Aug. 4, 2005

(54) Centralized medication management system

(76) Inventor: Timothy W. Vanderveen, Poway, CA (US)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 10/750,032

(22) Filed: Dec. 31, 2003

(51) Int. Cl. G06F 17/60

(52) U.S. Cl. 705/3

(57) ABSTRACT

A system and method for monitoring, managing and controlling medication delivery from a central location is provided. A central computer displays medication orders and ongoing medication administrations for a health care facility. The central computer checks medication delivery against a database of medication administration guidelines, including guidelines for medication interactions with other medications and with patient conditions and provides an indication of any detected incompatibilities. A clinician at the central location may adjust the medication administration parameters in response to detected incompatibilities and communicate with a caregiver at the point of care to provide decision support. In one embodiment, the central location is a pharmacy at the healthcare facility.

### BACKGROUND OF THE INVENTION

The present invention relates generally to systems and methods for managing patient care in a health care facility, and more particularly, to systems and methods for monitoring, managing and controlling medication orders and medication delivery from a central location.

Medication errors, that is, errors that occur in the ordering, dispensing, and administration of medications, regardless of whether those errors caused injury or not, are a significant consideration in the delivery of healthcare in the institutional setting. Additionally, adverse drug events (“ADE”), which are a subset of medication errors, defined as injuries involving a drug that require medical intervention, and representing some of the most serious medication errors, are responsible for a number of patient injuries and death. Healthcare facilities continually search for ways to reduce the occurrence of medication errors. Various systems and methods are being developed at present to reduce the frequency of occurrence and severity of preventable adverse drug events (“PADE”) and other medication errors. In the administration of medication, focus is typically directed to the following five “rights” or factors: the right patient, the right drug, the right route, the right amount, and the right time. Systems and methods seeking to reduce ADE's and PADE's should take these five rights into consideration.

Most hospitals today have a pharmacy equipped with a computerized system for entering, preparing, and tracking prescriptions, managing drug inventory, checking for drug incompatibilities, and printing prescription orders and labels. Such systems, however, do not enable the pharmacy to manage the subsequent administration of the prescribed medication to ensure proper administration. It would be advantageous to have an integrated system that provides centralized monitoring, management and control of medication delivery from the pharmacy or other central location to more efficiently utilize the expertise of the pharmacist or other clinician.

It would also be advantageous to have a care management system that combines all the various medication order and administration services of a healthcare facility into an integrated, automated system that checks and documents the delivery of therapeutic and other drugs to the patient. Such a system would prevent administering an inappropriate medication to a patient by checking the medication against a database of known allergic reactions and/or side-effects of the drug against the patient's medical history. The integrated system should also provide doctors, nurses, and other care-givers with updated patient information at the bedside, notify the facility's pharmacy when an additional drug is required, or when a scheduled treatment is running behind schedule, and automatically update the facility's accounting database each time a medication or other care is given.

Hospitals and other institutions continuously strive to provide quality patient care. Medical errors, such as where the wrong patient receives the wrong drug at the wrong time, in the wrong dosage, or even where the wrong surgery is performed, are a significant problem for all healthcare facilities. Many prescription drugs and injections are identified merely by slips of paper on which the patient's name and identification number have been hand-written by a nurse or technician who is to administer the treatment. For a variety of reasons, such as the transfer of patients to different beds and errors in marking the slips of paper, the possibility arises that a patient may be given an incorrect treatment. This results in increased expense for the patient and hospital that could be prevented using an automated system to verify that the patient is receiving the correct care. Various solutions to these problems have been proposed, such as systems that use bar codes to identify patients and medications, or systems allowing the beside entry of patient data. While these systems have advanced the art significantly, even more comprehensive systems could prove to be of greater value.

Delivery, verification, and control of medication in an institutional setting have traditionally been areas where errors can occur. In a typical facility, a physician enters an order for a medication for a particular patient. This order may be handled either as a simple prescription slip, or it may be entered into an automated system, such as a physician order entry (“POE”) system. The prescription slip or the electronic prescription from the POE system is routed to the pharmacy, where the order is filled. Typically, pharmacies check the physician order against possible allergies of the patient and for possible drug interactions in the case where two or more drugs are prescribed, and also check for contra-indications. Depending on the facility, the medication may be identified and gathered within the pharmacy and placed into a transport carrier for transport to a nurse station. Once at the nurse station, the prescriptions are once again checked against the medications that have been identified for delivery to ensure that no errors have occurred.

Typically, medications are delivered to a nurse station in a drug cart or other carrier that allows a certain degree of security to prevent theft or other loss of medications. In one example, the drug cart or carrier is divided into a series of drawers or containers, each container holding the prescribed medication for a single patient. To access the medication, the nurse must enter the appropriate identification to unlock a drawer, door, or container. In other situations, inventories of commonly-used drugs may be placed in a secure cabinet located in an area at or close by a nurse station. This inventory may contain not only topical medications but oral, IM-, and IV-delivered medications as well. Nurse identification and a medication order number are typically required to gain access to the cabinet.

The nurse station receives a listing of drugs to be delivered to patients at intervals throughout the day. A nurse or other care-giver or other qualified person reads the list of medications to be delivered, and gathers those medications from the inventory at the nurse station. Once all of the medications have been gathered for the patients in the unit for which the nurse station is responsible, one or more nurses then take the medications to the individual patients and administer the dosages.

Such a system though may not be capable of thoroughly verifying that the appropriate regimen is being delivered to a patient in the case where IV drugs are being delivered. For example, a nurse may carry an IV bag to a particular patient area, hang the bag, program an infusion pump with appropriate treatment parameters, and begin infusion of the medication. The applicable hospital control system, such as the pharmacy information system, may not know that the patient has received the medication, and if the information is lost somewhere, the possibility exists of medicating the patient twice. Thus, there may be a break in the link of verification that the medication is being properly delivered to the patient if an event occurs resulting in a deviation from the desired treatment parameters.

Moreover, even where the right medication arrives at the right patient for administration, incorrect administration of the medication may occur where the medication is to be administered using an automated or semi-automated administration device, such as an infusion pump, if the automated device is programmed with incorrect medication administration parameters. For example, even where the medication order includes the correct infusion parameters, those parameters may be incorrectly entered into an infusion pump, causing the infusion pump to administer the medication in a manner that may not result in the prescribed treatment. The nurse may also start an infusion at the wrong time or forget to administer an infusion, resulting in incorrect treatment that may interfere with other scheduled medications prescribed by the physician.

One attempt at providing a system with built-in safeguards to prevent the incorrect entry of treatment parameters utilizes a customizable drug library which is capable of monitoring the parameter entry process and interacting with the care-giver should an incorrect entry or an out of range entry be attempted. In such a case, an alert is communicated to the care-giver that the parameter entered is either incorrect or out of a range established by the institution where care is being provided. However, this system only provides verification at the point of care which may not integrate all the relevant data to ensure correct administration of a medication. For example, where a medication is administered at the wrong time, an incompatibility with a subsequently prescribed treatment may arise and yet not be detected.

Hence what has been recognized as a need, and has heretofore been unavailable, is an integrated system for managing and controlling patient care which includes centralized medication monitoring, management and control of medication orders and delivery to achieve accurate, reliable, efficient, and cost-effective delivery of health care to patients. The system would further be capable of providing decision support at the point of care from a central location to improve medication delivery. The invention fulfills these needs and others.

### INVENTION SUMMARY

Briefly, and in general terms, the present invention is directed to a new and improved information management system and method capable of monitoring, managing and controlling medication orders and the delivery of medication from a central location.

In one aspect of the present invention, there is provided a patient care system comprising a plurality of medication administration devices for delivering medication to a plurality of patients, a memory associated with each medication administration device for storing medication administration information associated with the medication delivered to each patient, the medication administration information including a plurality of medication administration parameters and a parameter value associated with each medication administration parameter, a central processor configured to receive medication administration information from each of the medication administration devices, a database operatively connected to the central processor for storing medication administration guidelines representing acceptable values for the medication administration parameters, and means for communicating medication administration information from each of the medication administration devices to the central processor, wherein the central processor is further configured to compare the parameter values to the acceptable values for the parameters in the medication administration guidelines.

In a more detailed aspect, the system further comprises a central computer display operatively connected to the central processor and the central processor is further configured to display the medication administration information on the central computer display. In further detailed aspects, the central computer display is located in a pharmacy. The system further comprises means for communication between a caregiver located at one of the medication administration devices and a clinician located at the central computer display. The central processor is further configured to provide a visual indication on the central display if one of the parameter values does not fall within the acceptable values for the parameter in the corresponding medication administration guideline. In more detailed aspects, the system further comprises means for a clinician to adjust the medication administration parameter values in response to the visual indication, and the system further comprises means for the clinician to report to a caregiver at the point of care the adjusted medication administration parameter values.

In other detailed aspects, the central processor is further configured to automatically adjust the medication administration parameter values in response to an indication that one of the parameter values does not fall within the acceptable values for the parameter in the corresponding medication administration guideline. The central processor periodically compares the parameter values to the acceptable values for the parameters in the medication administration guidelines throughout the administration of the medication.

In one detailed aspect, the medication administration parameters include current medication administration device operating parameters. In another detailed aspect, the medication administration guidelines include the acceptable values for the medication administration parameters based on medication indication data. In yet another detailed aspect, the medication administration guidelines include the acceptable values for the medication administration parameters based on patient condition data. In more detailed aspects, the system further comprises a memory operatively connected to the central processor for storing patient condition data associated with each patient and the processor is further configured to compare the parameter values to the acceptable values for the parameters in the medication administration guidelines corresponding to the stored patient condition data associated with each patient. The patient condition data for each patient includes current physiological status.

In still another detailed aspect, the system further comprises a memory in which is stored medication order information for a plurality of patients, the medication order information including a plurality of prescribed medication administration parameters for delivering medication to each patient and a parameter value associated with each prescribed medication administration parameter, and the processor is further configured to compare the parameter values of the prescribed medication administration parameters to the acceptable values for the medication administration parameters in the medication administration guidelines. In a more detailed aspect, the system further comprises a central computer display operatively connected to the central processor and the central processor is further configured to display the medication order information and the medication administration information on the central computer display.

Also provided is a method for centralized monitoring of medication administration for a plurality of patients comprising monitoring medication administration information associated with medication delivered to each patient, the medication administration information including a plurality of medication administration parameters and a parameter value associated with each medication administration parameter, storing a database of medication administration guidelines representing acceptable values for the medication administration parameters, communicating the medication administration information and the medication administration guidelines to a central location, comparing the parameters values to the acceptable values for the parameters in the medication administration guidelines and providing an indication at the central location if one of the parameter values does not fall within the acceptable values for the parameter in the corresponding medication administration guideline.

In a detailed method aspect, the method further comprises displaying the medication administration information on a computer display at the central location. In a more detailed aspect, providing an indication at the central location includes displaying an alert on the computer display.

Other detailed aspects include adjusting the medication administration parameters values from the central location in response to the indication, as well as communicating information from the central location to a care-giver located at the point of care. Another detailed aspect includes periodically comparing the parameter values to the acceptable values for the parameters in the medication administration guidelines throughout the administration. In yet another detailed aspect, the medication administration guidelines include the acceptable values for the medication administration parameters based on patient condition data. In still another detailed aspect, the medication administration guidelines include the acceptable values for the medication administration parameters based on medication indication data.

Other aspects and advantages of the invention will become apparent from the following more detailed description when taken in conjunction with the accompanying drawings of illustrative embodiments.

### BRIEF DESCRIPTION OF THE DRAWINGS

FIG. 1 is a graphical representation of a care management system incorporating principles of the present invention;

FIG. 2 is a functional block diagram of the care management system of FIG. 1 additionally showing an interface with other institutional information systems;

FIG. 3 is a functional block diagram of the software modules that comprise the care system of FIGS. 1 and 2;

FIG. 4 presents a computer screen listing of the infusions in progress showing the drug being administered, the time remaining, and the patient's name;

FIG. 5 shows a patient IMAR (integrated medication administration record) showing scheduled medications and windows around the scheduled times;

FIG. 6 shows a computer screen task list for a partial floor of a hospital in which times for administration in a certain time period are set out along with the patient name and drug to be administered;

FIG. 7 shows a computer screen used for rescheduling the administration of an order;

FIG. 8 presents a computer screen containing an overview of a partial floor of a hospital in which various patients' rooms are shown with the names of the patient;

FIG. 9 is a schematic diagram illustrating a database of medication administration guidelines according to aspects of the present invention;

FIG. 10 is a graphical representation of another embodiment of the care management system showing the clinical devices connected to the local area network through a bedside data concentrator;

FIG. 11 is a graphical representation of still another embodiment of the care management system showing the clinical devices transmitting and receiving information from the local area network through RF transmitting/receiving equipment;

FIG. 12 is a graphical representation of another embodiment of the care management system of the present invention where all of the hardware elements of the local area network communicate with each other using RF transmitting/receiving equipment; and

FIG. 13 is a graphical representation of another embodiment of the care management system of the present invention wherein a medication database carrier provides means for communication between the pharmacy and a care-giver at the point of care using either a hard wired or wireless communication system.

### DETAILED DESCRIPTION OF THE PREFERRED EMBODIMENTS

The present invention provides a system and method for monitoring medication delivery from a central location, such as a pharmacy at a healthcare facility. Additionally, the system provides decision support from the central location to caregivers at the point of care for delivering medication.

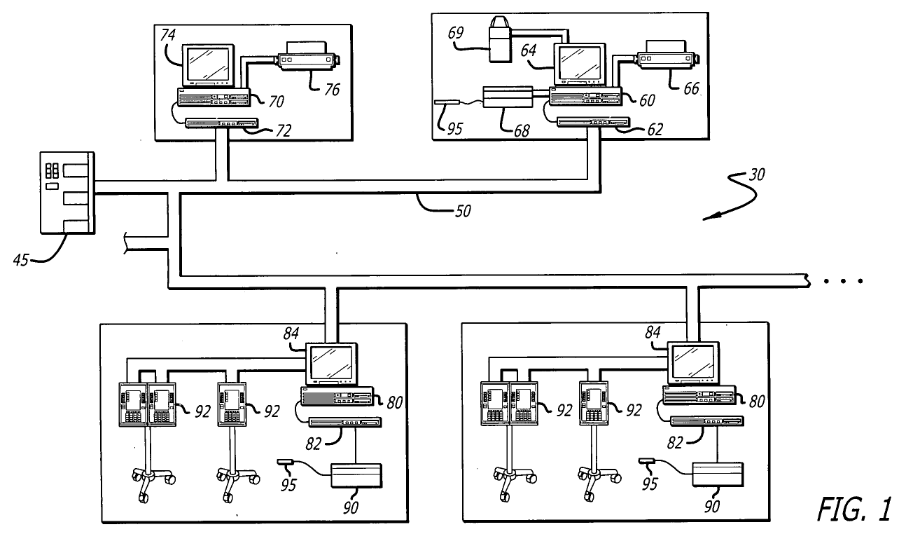

Referring now to the drawings, and more particularly to FIG. 1, there is shown generally an integrated hospital-wide information and care management system 30 including one embodiment of the point-of-care management system 30 of the present invention. The care management system embodiment shown in FIG. 1 is depicted as being configured as a local area network with a file server 45 to which are connected a pharmacy computer 60, a nursing station 70, and bedside CPUs 80. The file server 45 stores programs and data input and collected by the various computers in the local area network. Various application modules of the patient management system may be resident in each of the computers in the network and will be discussed in more detail below. Ethernet cabling of a local area network 50 is used to connect various CPUs to the file server. The file server 45 also has both local and network hard disk storage for storing programs as well as data gathered on the network.

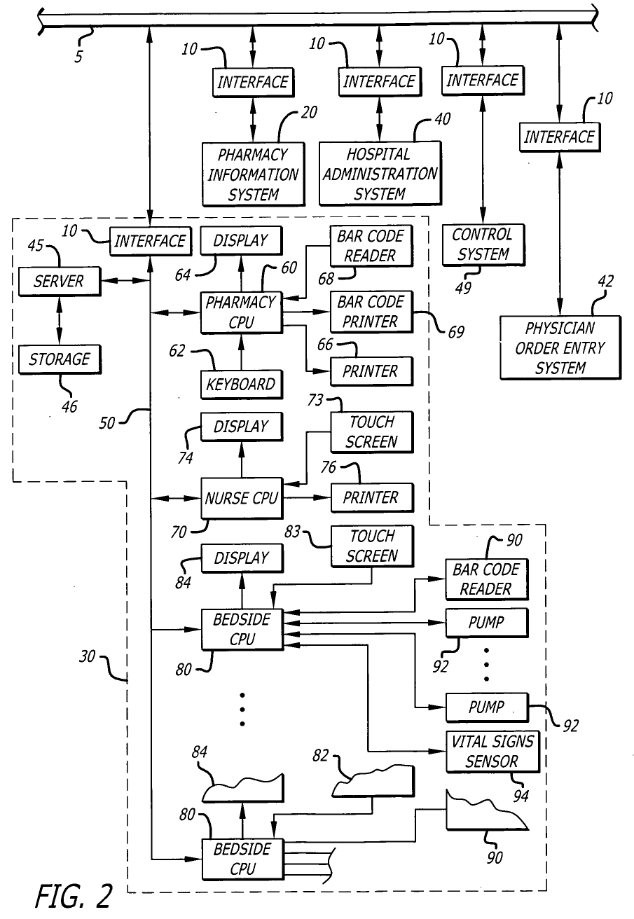

Referring now to both FIGS. 1 and 2, a functional block diagram of the patient care management system 30 of FIG. 1 is shown in FIG. 2 interfaced with and connected to other hospital information management systems to form an integrated information and care management system. As shown in FIG. 2, various subsystems of a facility's information management system are connected together by way of a communication system 5. The communication system 5 may be, for example, a local area network (LAN), a wide area network (WAN), Internet- or Intranet-based, or some other telecommunications network designed to carry signals allowing communications between the various information systems in the facility. For example, as shown in FIG. 2, the communication system 5 connects, through various interfaces 10, a pharmacy information system 20, a hospital administration system 40, a physician order entry system 42, and a control system 49.

Each of the various systems 20, 30, 40, 42 and 49 are typically interconnected via a network 5 and appropriate interfaces 10, and generally comprise a combination of hardware such as digital computers which may include one or more central processing units, high speed instruction and data storage, on-line mass storage of operating software and short term storage of data, off-line long-term storage of data, such as removable disk drive platters, CD ROMs, or magnetic tape, and a variety of communication ports for connecting to modems, local or wide area networks, such as the network 5, and printers for generating reports. Such systems may also include remote terminals including video displays and keyboards, touch screens, printers and interfaces to a variety of clinical devices. The processors or CPUs of the various systems are typically controlled by a computer program or programs for carrying out various aspects of the present invention, as will be discussed more fully below, and basic operational software, such as a Windows™ operating system, such as Windows N™, or Windows 2000™, or Windows XP™, distributed by Microsoft, Inc., or another operating program distributed, for example, by Linux, Red Hat, or any other suitable operating system. The operational software will also include various auxiliary programs enabling communications with other hardware or networks, data input and output and report generation and printing, among other functions. Further, while the control system 49 is shown as a separate system in FIG. 2, it will be understood that the control system 49 and the associated mass storage may also be incorporated into another element, such as an infusion pump or other system.

The communication system 5 may comprise, for example, an Ethernet (IEEE 522.3), a token ring network, or other suitable network topology, utilizing either wire or optical telecommunication cabling. In an alternative embodiment, the communication system 5 may comprise a wireless system, utilizing transmitters and receivers positioned throughout the care-giving facility and/or attached to various computers, clinical devices and other equipment used in the facility. In such a wireless system, the signals transmitted and received by the system could be radio frequency (RF), infrared (IR), or other means capable of carrying information in a wireless manner between devices having appropriate transmitters or receivers may be used. It will be immediately understood by those skilled in the art that such a system may be identical to the system set forth in FIG. 2, with the exception that no wires are required to interconnect the various aspects of the system. The LAN 50 may also comprise one of the communications systems described above.

In one embodiment, the file server 45 of the care management system is connected by a local area network (LAN) 50 to computers and other peripheral equipment located in the institution's pharmacy, at nursing stations located throughout the institution, and at the patient's bedside. In the embodiment shown, the module located in the pharmacy comprises a central processing unit 60 to which is attached a video display 64 and a keyboard 62 for entry and display of patient information and drug parameters. Also attached to the pharmacy CPU is a bar code reader 68 which is adapted to read barcode labels that may be attached to drug containers, equipment, or caregiver identification badges as will be more fully discussed below. Also connected to the pharmacy CPU 60 is a bar code printer 69 and a printer 66 used for generating reports containing information about patient history and/or patient treatment. The printer 66 may also be used to print barcode labels generated by the pharmacy CPU 60 after patient or drug data is input by a technician or pharmacist into the pharmacy computer 60 using the keyboard 62 or other means. In accordance with one embodiment of the present invention, the pharmacy CPU is located at a central pharmacy that serves an entire healthcare facility or a particular section or unit of the facility. As will be discussed in more detail below, with the use of the pharmacy CPU, a pharmacist can monitor all medication orders for the facility or specified unit, as well as the progress of those orders, and manage the administration of medication to ensure that the medication is administered to the right patient, in the right dose, along the right route and at the right time.

Another computer, herein referred to as the nursing CPU 70, is located at a nursing station. Nursing stations are typically located in various sections and/or floors of a hospital or clinic and typically provide a central location for record storage and monitoring for a number of patient beds. The nursing CPU 70 located at the nurse station typically includes a video display 74 for displaying patient or other information pertaining to the operation of the particular unit of the institution, and a keyboard 72, mouse, touch screen 73, or other means for entering patient data or specific commands instructing the nursing CPU 70 to generate reports relating to either the patient's medical history or the course and progress of treatment for an individual patient on the attached printer 76 or on the video display 74. As will be discussed more fully below, the nursing station CPU 70 may also generate other reports such as, for example, a printout of drugs scheduled to be administered to patients, productivity measurements such as, for example, the amount of time a nurse spends with a patient or other reports useful for assisting in the efficient operation of the particular unit or the hospital. For example, a report listing the actual times of administration versus the scheduled times for administration may be prepared to assist in evaluation of staffing requirements.

Each care unit associated with the nursing station typically comprises one or more patient beds located in private rooms, shared rooms, or open or semi-open wards that contain multiple beds. In accordance with an embodiment of the present invention, each private room, semi-private room, or ward area has at least one bedside CPU 80 for monitoring and treating one or more patients. Each bedside CPU 80 has a video display 84 and a keyboard 82, mouse, touch screen 83 or other device. The bedside CPU 80 can be used by a nurse, physician or technician to access a variety of institutional databases to display a variety of information about a particular patient. This information can include an on-line, real-time, graphical patient medication administration record (MAR) that is derived from the patient's medication profile maintained by the hospital's pharmacy information system 20. The bedside CPU 80 also allows remote access to a patient's records stored by the file server 45 to display medication history for the patient. This medication history includes a listing of all drug or other treatments including past, present and future deliveries to the patient. Additionally, access to administration records of the hospital's administration system 40 is available through the network 5. Alternatively, this information may also be stored, as will be discussed in more detail below, in a medication database carrier, the pharmacy information system, or another system. While a bedside CPU has been described, it will be understood that what is intended is a system having a computer or processor located in the general vicinity of a patient. Such a computer or processor, besides being embodied in a bedside computer, may also be incorporated in a handheld or vital signs device, a laptop computer, a personal digital assistant (PDA) and the like.

In one embodiment of the present invention, the bedside CPU further includes a database including a library or libraries of information concerning past and present medical administration activities and/or institutional guidelines for appropriate parameters for administration of various medications. For example, the guidelines may include institutionally established guidelines or limits on drug administration parameters, such as dosage, frequency of administration, and other delivery related information such as, for example, appropriate flow rates and infusion durations for programming infusion pumps. Additionally, the guidelines may encompass guidelines for providing drug administration appropriate to particular patient treatment areas having different sets of delivery parameters for similar medications, such as medication administration directed to geriatric, pediatric and oncology patients. Guidelines may also be included that are directed to particular therapy regimens, such as chemotherapy regimens or regimens for treating chronic infection or pain. The guidelines library stored in the bedside CPUs may be accessible by the medication administration devices during programming of an infusion. Alternatively, the database may be stored directly in the medication administration device or another computer connected to the network and accessible by the medication administration device. In one embodiment, the database may be stored in the file server 45 or the pharmacy information system 20 and accessed and controlled by the central pharmacy to supervise medication administrations delivered by the medication administration device.

Each bedside CPU 80 can be connected through an appropriate interface to a variety of peripheral equipment. For example, a barcode reader 90 capable of reading barcodes on a patient's wristband or medication container; an infusion pump 92 for delivering medication to the patient in a predetermined, controlled manner; or various sensors 94 that can automatically monitor a patient's vital signs and send signals representative of these vital signs to the computer through an appropriate interface for storage and later retrieval by a selected software application to provide a graphic display of the patient's vital signs during the course of treatment.

In a different embodiment where RFID (RF identification) tags are used with medication, patients, equipment, or in other ways, the bedside CPU may also include an interrogator or RFID reader (not shown) for use with the RFID tags.

A plurality of bedside CPUs are shown in the drawing; however, more or fewer may exist depending on the particular system and hospital requirements.

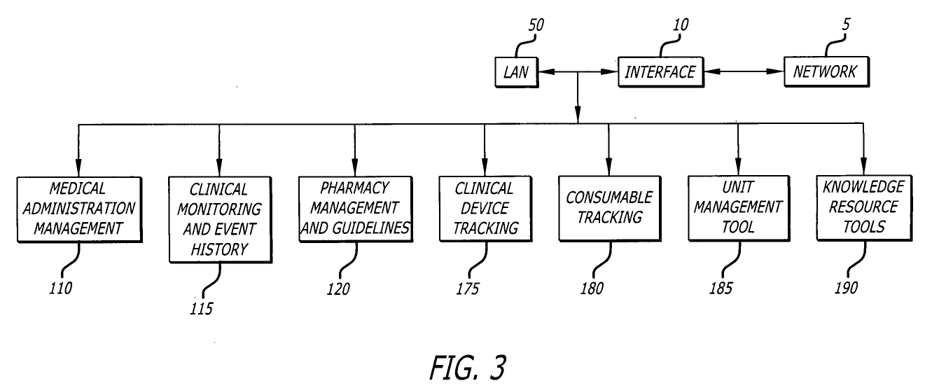

Referring now to FIG. 3, a block diagram illustrating the various application software modules comprising an illustrative embodiment of the care management system of the present invention is shown. The care management system's application software is modular in construction to allow installation and operation of the system with only one or more of the application software groups present. This provides flexibility in meeting the widely varying needs of individual institutions where cost and complexity may be an issue or where the full system is not needed. Each of the modular applications, however, is fully integratible into the system.

The programs of the care management system 30 control alarms or alerts generated by one of the modular applications. Alarms are routed automatically to the appropriate video display. For example, an occlusion alarm generated by a pump 92 may remain local for a predetermined period. After that period the patient's bedside computer 80 may then broadcast the alarm by causing the alarm to be communicated over the LAN 50 to alert other hospital staff of a potential problem or to cause a particular person responsible for the care of a patient, such as, for example, a physician or nurse, to be paged.

Each of the modular applications will now be described in detail. The operation of each of these modular applications in a clinical setting will be discussed more fully below. The medical administration management module 110 integrates medical order information, infusion pump monitoring, and barcode technology to support the real-time verification and charting of medications being administered to a patient. The medical administration management module 110 creates and maintains an on-line, real-time, patient-specific medication administration record (“MAR”) or integrated medication administration record (“IMAR”) for each patient. This medical administration module 110 contains all of the information generated in the institution regarding the care provided to the patient. The medication administration management module 110 gathers information from the various nursing and bedside CPU's 70, 80 (FIG. 1) comprising the peripheral hardware of the care management system 30 that is distributed throughout the institution. For example, when a physician attending a patient diagnoses an illness and determines an appropriate course of treatment for the patient, the physician may prepare a handwritten medical order specifying the desired therapeutic treatment as well as any appropriate parameters such as dosage and/or period of administration. The written prescription is sent through the institutional mail system to the pharmacy where it is then entered into the pharmacy information system 20 through a dedicated terminal, or other means, and is then entered into the care management system 30.

In another embodiment, the physician may enter the order directly into the POE system 42 which transmits the order to the pharmacy information system 20. The physician may also access the pharmacy information system 20 through another dedicated terminal or through the care management system 30 via the network 5 using either a nursing CPU 70 or a bedside CPU 80. Alternatively, the treatment order may be entered by a nurse or other qualified caregiver into either the pharmacy information system 20 or the care management system 30.

Typically, a patient identification bracelet is used in hospitals and other institutional settings to ensure that each patient is able to be identified even if the patient is unconscious or otherwise unable to respond to questioning. A barcode is printed on a label that is attached to the patient identification bracelet and has encoded within its sequence of bars the information necessary to identify the patient. This barcode may be read using a computerized barcode reader, such as those shown connected to the pharmacy CPU 60 and the bedside CPUs 80 (FIG. 1). Drug containers may also be identified by a bar code label that represents the patient identification and the medical order number, and any other information the institution finds helpful in dispensing the drug and tracking the treatment. The barcode may also be read using a barcode reader, and, using suitable application software such as that included within the medical administration management module 110, discussed below, can be used to link the drug container and its contents with the patient identification bracelet affixed to a patient to ensure the right drug is delivered to the right patient at the right time in the right manner. Such identification bracelets and labels may alternatively include a passive device, such as RF identification, magnetic stripes, smart chips and other wireless devices that are capable of being interrogated and communicating information to a querying device, instead of a barcode.

When the medication to be administered is of the type that is typically delivered to the patient using an infusion pump, the medical administration management module 110 automatically records the start time of the infusion, queries the pump periodically throughout the infusion and maintains a continuous log of the infusion, and records the end time of the infusion and the volume infused in a patient's MAR.

Because the medical administration management module 110 maintains an on-line, real-time, patient specific graphical medication administration record that includes both past, present and future scheduled medications, a nurse and/or pharmacist may select a scheduled dosage on the MAR and indicate that it will not be administered for specified reasons selected from a list of options that are dependent upon the health status of the patient at a particular time. This system also allows a nurse to select a scheduled dose on the MAR, and record notes and observations about the dose selected from a list of options. The medical administration management module 110 also provides on-line, real-time help screens that can be accessed by a nurse or other caregiver to display specific information about selected medication and dose to be dispensed.

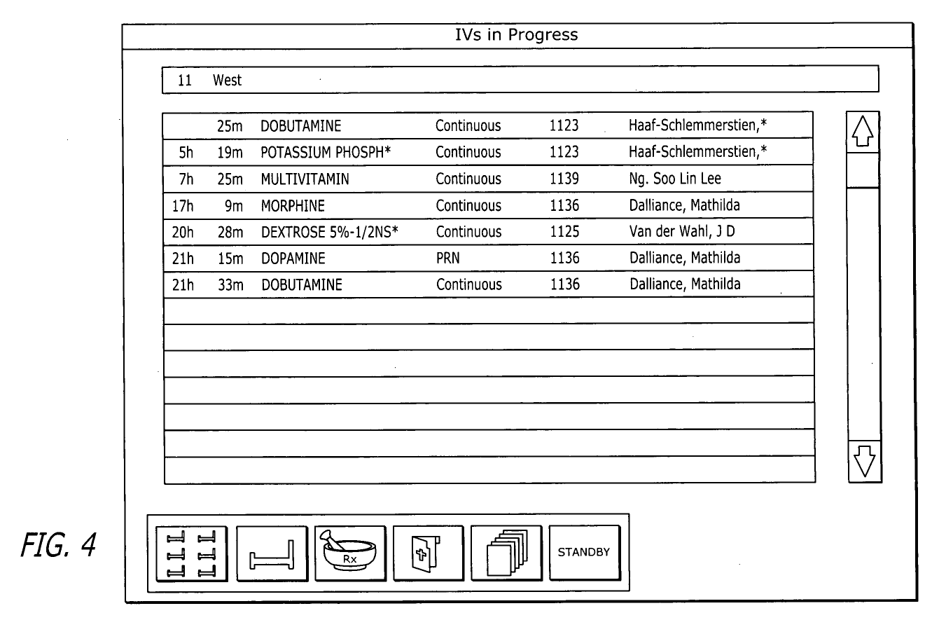

The medical administration management module 110 provides a list of on-going infusions that can be displayed on the video display of the pharmacy CPU 60 such as is shown in FIG. 4. Drug administrations that will terminate within a preselected time period may be distinguished from other administrations by color highlighting or other means. The time remaining, drug, and patient name are presented as well as buttons for program control. Other displays may also be available including a display of pending infusions or infusions scheduled to begin within a preselected time period.

The medical administration management module 110 records and maintains in a stored file a log of alerts that are generated when any discrepancy is identified, for example, during the verification process which will be discussed more fully below. The medical administration management module 110 also allows the nurse and/or pharmacist to acknowledge and correct the discrepancy in real-time, or override the alert by entering the appropriate command. Even where the nurse is allowed to override the alert, the medical administration management module 110 prompts the nurse for a reason for each alert override and then automatically enters the reason into the MAR for the patient.

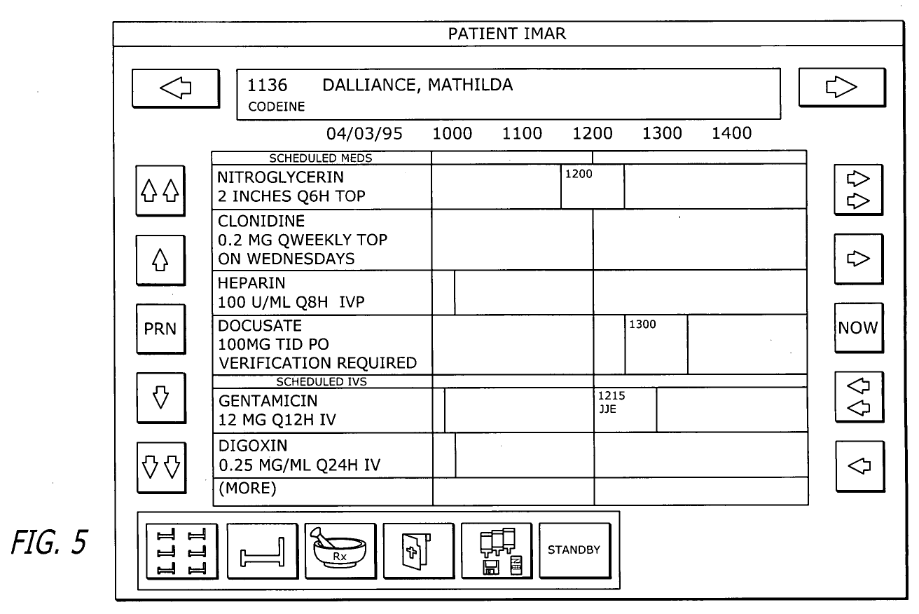

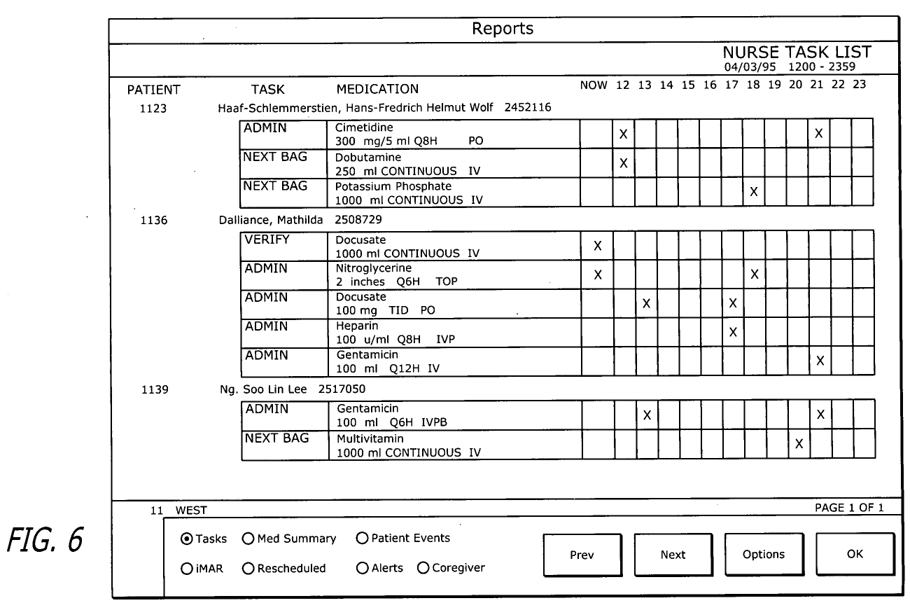

The medical administration management module 110 assists the nurse or other health care professional in efficiently delivering care to the patients by providing the ability to perform on-line queries of the patient's MARs and produce reports designed to assist the nurse in planning medication administration and in scheduling the workload of dispensing the medication to the many patients for which a nursing unit is typically responsible. For example, the video display may be color coded to indicate the status and schedule of each drug administration, such as the patient's IMAR shown in FIG. 5. A drug delivery window extending from thirty minutes prior and thirty minutes after the scheduled administration time may be indicated by a yellow band on the display. Other reports such as the FIG. 6 task list may, for example, include scheduling of drug administrations to ensure proper medication of the patient while distributing the workload over a period of time to ensure that all medication is given promptly. The system may also display either visuals alerts on the nurse station video display 74 or produce a printed report on the printer 76 to provide a permanent record of any medication administration that is running late or has been rescheduled. The medical administration management module 110 may be programmed to operate in an automatic fashion, automatically providing standard reports at the nursing station at predetermined intervals, such as, for example, every 30 minutes, as determined by the needs of the particular nursing unit and institution. The same information and displays may also be available on the pharmacy CPU 60 to permit the pharmacist to monitor and oversee the nurses in conjunction with the pharmacy management and guidelines module discussed below.

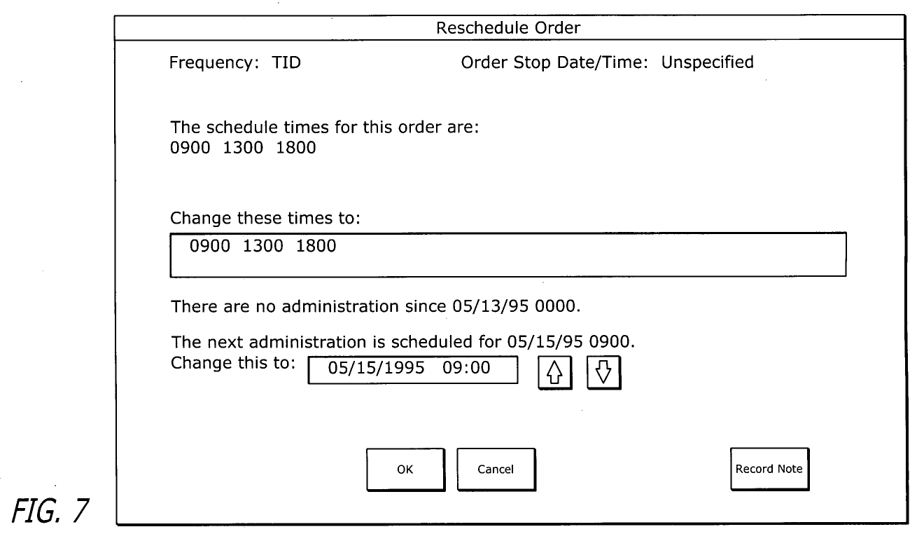

The clinical monitoring and event history module 115 shown in FIG. 3 is designed to monitor a variety of clinical devices attached to the network in a real-time manner and provides information about those devices to monitoring stations located elsewhere on the network. For example, the clinical monitoring and event history module 115 can be configured to monitor a plurality of clinical devices that are in use to deliver medication to patients in the private rooms, semi-private rooms or ward areas in a nursing unit. The clinical monitoring and event history module 115 retrieves real-time data from each device, and displays a visual representation of each device including all significant data related to its status and settings on the video display 74 connected to the Nursing CPU 70 (FIGS. 1 and 2). For example, in the case where the clinical monitoring and event history module 115 is monitoring an infusion pump 92, a nurse at the nursing station can access the status for that pump wherein the display 74 attached to the nurse CPU 70 then displays information regarding the status of the infusion being performed at that time. For example, information can include the name of the drug being infused, the patient's name, the scheduled start, the actual start of infusion, the scheduled end of infusion, the projected end of infusion, the amount of drug infused, the amount of drug remaining to be infused and any alert or discrepancy conditions that may need attention by the nurse. Similar displays of real-time information from clinical devices throughout the entire institution may also be provided on display 64 at the pharmacy CPU 60. Because the care management system 30 is a fully integrated system, the medical administration management module 110 works in concert with the clinical monitoring and event history module 115 so that a pharmacist, nurse, doctor or technician, after evaluating the status of the infusion displayed on a video display 64, 74 or 84 at the pharmacy CPU 60, the nursing CPU 70 or the bedside CPU 80, or at another remote (i.e., not at the location of the patient) computer system, including a laptop or PDA, may, by using the keyboard 62 or touch screen 73, 83 of the computer, adjust the infusion regimen accordingly using, for example, a screen displayed on the video display 64, 74, 84 as shown in FIG. 7.

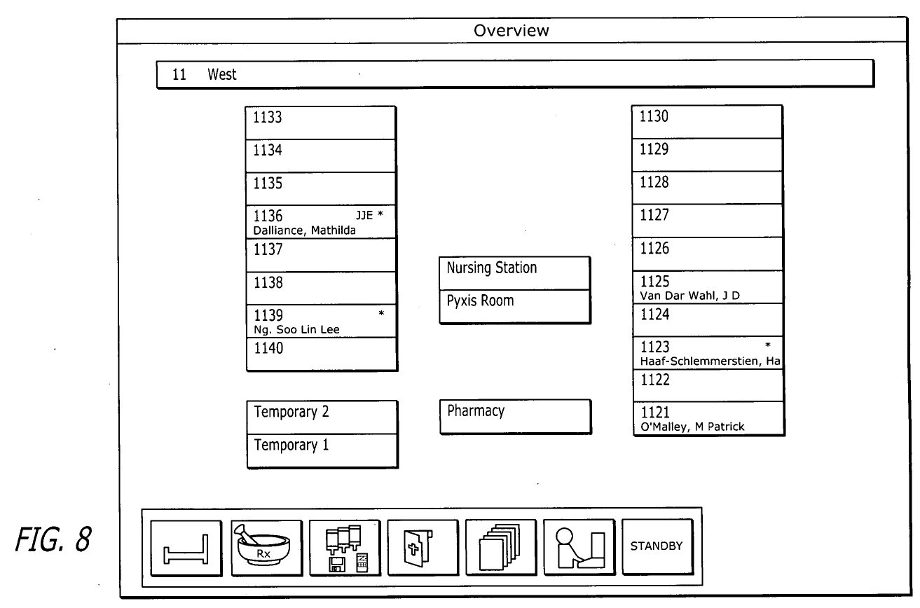

The clinical monitoring event history module 115 may also be programmed to immediately display alarm conditions on remote monitoring screens, such as the video display 74 attached to the nursing CPU 70, as the alarm occurs. For example, the status of each patient's infusion can be represented on a video display at the nursing station as shown by the OVERVIEW computer screen in FIG. 8. When an alert occurs, the box representing the patient's room flashes red to attract attention to the alert. Displaying the alarm condition in this manner allows a nurse to quickly and easily identify the patient from the nursing station and take appropriate action to address the condition causing the alarm. The system may also be programmed to display certain alarms that have been identified as particularly important events at other video displays located throughout the institution, such as the video display 64 attached to the pharmacy CPU 60 located in the institution's pharmacy. The manner of overview display in FIG. 8 also facilitates record update. For example, when patients move rooms, clicking on the patient's name, dragging that patient to the new room, and unclicking will cause the records to reflect the patient's move and the display will now show the patient in that room.

The pharmacy management and guidelines module 120 provides centralized monitoring, management and control of medication orders and medication delivery from the pharmacy in one embodiment of the present invention. In this embodiment, the pharmacy acts as a control center for medication administration, ensuring not only that prescriptions, or medical orders, are accurate and safe, but also that the subsequent administrations of the medications are proper. The pharmacy management and guidelines module 120 works in conjunction with the medical administration management module 110 and the clinical monitoring and event history module 115 to provide all medication order information and medication administration information to the pharmacy CPU 60 (FIG. 1) through a variety of displays, such as the display in FIG. 4, and/or reports which may be printed on printer 66 (FIG. 1). Thus, the module 120 provides centralized display and monitoring of actual medication administration information, including actual medication administration parameters and the parameter values associated with each parameter, which may be represented by the current status and operating parameters of a medication administration device such as pump 92 and which may be stored in a memory of the medication administration device. This information may be compared to and displayed with the corresponding medical order information, including prescribed medication administration parameters. While each nurse CPU 70 generally receives some infusion information for those patients assigned to the associated nursing station, the pharmacy CPU is used to provide the pharmacist with full access to medication orders and medication delivery information institution-wide. A pharmacist may thus monitor the information from the pharmacy location and provide centralized support for medication administration throughout the entire institution.

Although described primarily with respect to a pharmacy, the centralized monitoring, management and control of medication orders and medication delivery may also occur from another central location in alternative embodiments. Thus, rather than operating on pharmacy CPU 60, module 120 may be used in conjunction with a different central computer or processor. As used herein, the term “central,” as in “central location” or “central processor,” generally refers to accessibility to more than one source of information or data, such as data accumulated from more than one patient or data accumulated from more than one clinical device. Thus, the central location may be located at the healthcare facility or may be a remote site connected to communication system 5 from which multiple sources of data may be accessed and monitored. Further, the medication monitoring and decision support may be provided by other types of qualified clinicians, including a multi-disciplinary team of clinicians, rather than by a pharmacist.

The displays and reports aid the pharmacist in reviewing and overseeing nurses' activities, such as their progress in delivering medications. The pharmacy CPU 60 may also generate displays informing the pharmacist when particular action by the nurse has been taken at the point of care. For example, displays may be generated when the nurse overrides an alert or reschedules a prescribed infusion.

This information may further be used by the pharmacist to provide decision support to the nurse or other caregiver. Thus, the pharmacist may intervene in response to any information reviewed on the display 64. Further, nurse actions such as overrides and rescheduling may also require approval from central pharmacy before they can be implemented. Nurses may also communicate with the pharmacist at the pharmacy CPU 60 to request advice on particular matters. The pharmacist can advise nurses and send instructions from the pharmacy CPU 60 to the nurse CPU 70, a bedside CPU 80 or a portable computer, such as a PDA or laptop. Instructions may also be sent through a medication database carrier or other portable computers, as discussed in more detail below, or a patient care device or clinical device, such as pump 92 (FIG. 1). The pharmacy management and guidelines module 120 may also enable the nurse and pharmacist to speak directly through the system of the present invention in order to provide decision support at the point of care. This feature may be accomplished in a variety of ways well known in the art, such as voice-over networks, text messaging and the like. The pharmacist and nurse or other care giver may communicate orally via the pharmacy CPU, a telephone located at the central pharmacy or other equipment at the pharmacy that supports such communication and a nurse CPU, bedside CPU, patient care device or medication database carrier that supports oral communication, or a mobile phone, accessible by the nurse.

The pharmacist may also monitor medication delivery to check that the medication is being properly provided in accordance with the specifications listed in the order. Deviations from the prescription, such as where the medication is administered at the incorrect time, can thus be detected. The pharmacy CPU 60 may also receive and display patient data from other sources in the network, such as patient condition data from vital signs monitors or the laboratory, which may warrant a change in the medication orders after they have been processed at the pharmacy. Modifications to the medication order may then be made in response to deviations or updated patient condition data. The pharmacy management and guidelines module 120 permits the pharmacist to change details of the medication orders in the patient's MAR maintained by the medical administration management module 110 and also provide alerts to the nurse notifying the nurse of the change. Thus, the pharmacy manages subsequent delivery of medications after preparing the order, thereby closing the loop with the pharmacy and allowing feedback from the pharmacy based on the real-time information.

As an example, complications may arise when a particular medication is delivered to a patient at an incorrect time. Late delivery of medication may inadvertently result in an incompatibility with another prescribed medication or a patient condition. Medications with adverse interactions may be administered at the same time or in close proximity when one of the medications is delivered late. Patient condition data, such as physiological status or even whether the patient has a full or empty stomach, may also cause incompatibilities when a medication is administered at the wrong time. The pharmacy CPU displays all data relevant to medication administration prior to and during delivery of the medication so the pharmacist can review the data and alter the medication order or advise the nurse on the updated proper treatment in view of a late medication or other detected incompatibility.

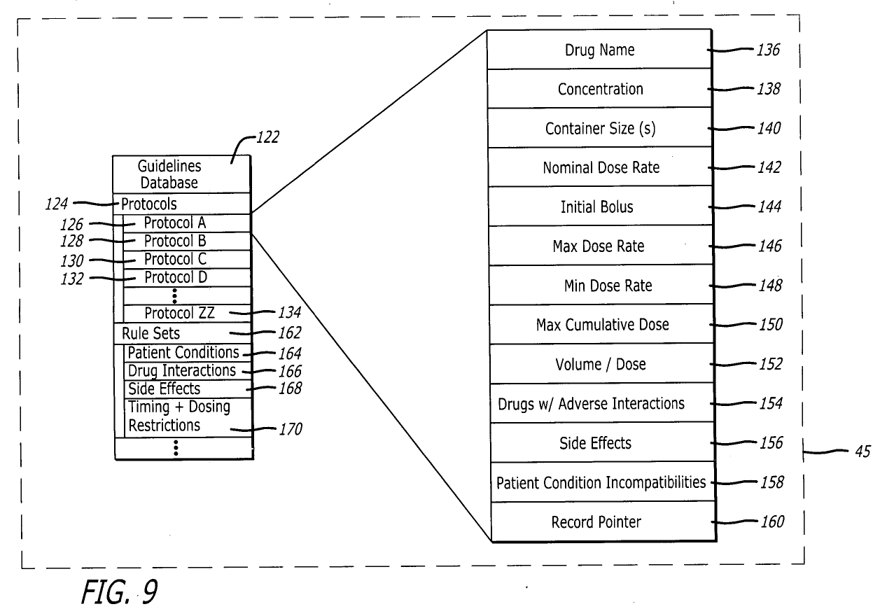

Patient care system 30 may further include one or more electronic databases, such as database 122 shown in FIG. 9, containing institutionally-established guidelines for medical treatments which is used by the guidelines module 120 to manage medication administration. As discussed previously, these institutional guidelines may provide acceptable values for parameters for administration of various medications. For example, the guidelines may include institutionally established guidelines or limits on medication administration parameters, such as dosage, frequency of administration, and other delivery related information such as, for example, appropriate flow rates and infusion durations for programming infusion pumps. Using the guidelines module 120, a central processor, such as pharmacy CPU 60, connected to network, may compare the values for actual medication administration parameters associated with medication administration devices to the acceptable values stored in the medication administration guidelines and display or otherwise report any parameter values that do not fall within the acceptable values. The processor may also automatically adjust the actual medication administration parameter values if the values do not fall within the acceptable values.

The database 122 may be stored in a memory of the information and care management system, such as in file server 45. Alternatively, the database 122 may be stored in the pharmacy information system 20 or in a memory of the pharmacy CPU 60 (FIG. 2). The term “database” or “data base” as used herein will be understood by those skilled in the art to be used as is commonly understood, that is, the term “data base” refers to a collection of values or information organized, formatted, and stored in such a manner as to be capable of being retrieved and analyzed using an appropriate program contained in software or other form.

Referring to FIG. 9, in one embodiment of the present invention, the database 122 contains guidelines including protocols and rules relating patient condition and medication indications to acceptable medical administration parameters. The database 122 may further include general drug library information, available treatment protocols, rule sets, and possibly other information for defining particular operating parameters and acceptable conditions for medication administration. In such a case, the guidelines database 122 may replace some or all of the guidelines provided on the bedside CPU or patient care device.

In the embodiment shown in FIG. 9, database 122 includes a protocol module 124 comprising a plurality of protocols 126, 128, 130, 132, 134. Each protocol includes a plurality of fields of default operating parameters. In some cases an infusion protocol may include a complete detailed infusion instruction with all of the default parameter values defined. Other infusion protocols may have partially defined parameters with additional data entry required by the user at the point of care. For example, protocol A 126 of FIG. 9 includes fields of default operating parameter values and other data for controlling a medication infusion pump. The fields of this example include drug name 136, concentration 138, container size(s) 140, nominal dose rate 142, initial bolus 144, maximum dose rate 146, minimum dose rate 148, maximum cumulative dose 150, volume/dose 152, adverse drug interactions 154, side effects 156, patient condition incompatibilities 158 and an ID field, record pointer 160, for identifying or “calling” the protocol record. Each field typically includes stored default parameter values that collectively define a specific infusion protocol. Some fields, such as drug interactions 154, include a reference or link to another database or drug library containing relevant information. Such references to commonly used data libraries allow data to be shared between protocols and to avoid duplicate storage and entry and to allow efficient updating of database information.

Different protocols typically include different fields and/or different parameter values. Thus, Protocol B 128 might include additional fields compared to Protocol A 126, where the additional fields define instructions and/or parameters for implementing one or more different infusions. Alternatively, Protocol B 128 could include the same fields as Protocol A 126, and differ only in terms of one or more parameter values in one of the fields. For example, both protocols could be for infusion of the drug dopamine, where one protocol has a concentration 138 value of 400 mg/250 mL while the other has a concentration 138 value of 800 mg/250 mL.

Still referring to FIG. 9, the Rule Sets module 162 of database 122 includes rules and/or algorithms that may be used to help define particular administration parameters. For example, Rule Sets module 162 could include an algorithm that modifies the maximum allowable infusion rate or some other parameter based upon data obtained from other sources in network 30, such as patient age, body weight or medical history from hospital administration system 40 or test results from the laboratory. Other rule sets in the Rule Sets module 162 may provide warnings or recommendations upon the occurrence of particular events within an infusion pump such as occlusion of the infusion line.

Still other rule sets within module 162 may contain algorithms that utilize measurements from one or more clinical device to modify operation of another clinical device, such as a medication administration device. For example, module 162 may contain a rule set that monitors blood pressure and intracranial pressure in a head trauma patient and calculates resulting perfusion pressure. The system then notifies the user, such as the pharmacist at the pharmacy CPU 60, when perfusion pressure falls outside of a defined range and recommends adjusting infusion rate of a therapeutic agent to increase blood pressure or to decrease intracranial pressure.

In one embodiment of the present invention, rules sets associated with patient conditions 164 and indications for medication, such as drug interactions 166, side effects 168 and timing and dosing restrictions 170, are provided. As an example, a rule for a timing restriction 170 may specify that two doses of a drug must be given 4 hours apart. These rule sets and related protocols 154, 156, 158 are advantageously incorporated into the centralized medication management system to ensure that medication orders are still safe and effective at the time of administration. In addition to initially checking these protocols and rule sets when the prescription is filled, the guidelines module 120 may also periodically or continuously check them until administration is complete to verify correct treatment.

In another example, a rule for a patient condition 164 may correlate administration of certain medications with the concentration of the medications in the patient's serum or other fluid. In such an embodiment, the centralized medication monitoring and management system is also capable of monitoring the sampling of a patient's serum or other fluid via network connection with a laboratory or patient monitor. With the centralized medication monitoring system having accurate, real-time information regarding infusion status, more timely measurements of the drug level can be made and more relevant calculations can be performed by the patient condition rule set 164 to determine any adjustments in the delivery of the drug. This rule may be used to guide adjustments in drug dosing to achieve therapeutic drug levels.

In yet another example, a rule for a patient condition 164 may correlate administration of medications with other laboratory response, such as clotting times for anticoagulants, blood pressure, heart rate, and other physiologic measurements. Further, by using drug interaction and potentiation information, one or more medication dosages may be adjusted to achieve the desired response.

Additionally, the protocols and rule sets may encompass guidelines for providing drug administration appropriate to particular patient treatment areas having different sets of delivery parameters for similar medications, such as medication administration directed to geriatric, pediatric and oncology patients. Guidelines may also be included that are directed to particular therapy regimens, such as chemotherapy regimens or regimens for treating chronic infection or pain. In this embodiment, a plurality of databases similar to database 122 may be provided with each one representing a particular configuration. A particular configuration database stored in a patient care device is selected based, at least in part, by patient-specific information such as patient location, age, physical characteristics, or medical characteristics. Medical characteristics include, but are not limited to, patient diagnosis, treatment prescription, medical history, medical records, patient care provider identification, physiological characteristics or psychological characteristics. As used herein, patient-specific information also includes care provider information (e.g., physician identification) or a patient care device's location in the hospital or hospital computer network.

The individual configuration databases may be treatment location specific (e.g. intensive care unit [ICU], neonatal intensive care unit [NICU], pediatrics, oncology, etc.), disease state specific (intracranial pressure management, bone marrow transplant, etc.), user specific (LPN, RN, physician, etc.), or created by any other rationale. One or more of the patient care devices such as infusion pumps 92 (FIG. 1) is capable of operating in several different modes, or personalities, with each personality defined by a configuration database. For example, according to one embodiment of the present invention, when a patient care device is located in the ICU it utilizes the ICU configuration database, and when device is located in the NICU it utilizes the NICU configuration database. Each database contains particular operating parameters, treatment protocols, features, etc. that configure device for use with patients in that unit of the hospital.

The clinical device tracking and reporting module 175 shown in FIG. 3 is used to maintain a record of the location of each clinical device and the history of its use in the institution. This system maintains a record of the current or last known location within the institution of each clinical device used in the institution, such as an infusion pump or vital sign sensor. Thus, the appropriate equipment can be easily located by a nurse or a technician for a given therapy regimen or vital sign measurement. This is particularly useful in a large hospital or clinic having many patient rooms, patient beds, or treatment areas where equipment may be temporarily misplaced. This system is also useful in those particular instances where an emergency occurs where treatment requires a particular piece of equipment. The status of that equipment can be easily ascertained from a remote video terminal, such as the video display 74 connected to the nursing CPU 70.

The clinical device tracking and reporting module 175 also maintains a record containing the usage history of each clinical device, including information about the patient it was used to treat, its location, the date, time, duration of use, any alarms that occurred and what medications were dispensed. This history may also contain the maintenance and calibration records for a clinical device. Such information can be queried on-line by technicians, nurses or other hospital administration personnel to generate reports to assist in locating the clinical device, report on the historical usage of the device, and to provide a log of preventative maintenance and equipment calibration. The efficient calibration of complex and sensitive clinical devices is particularly important in a heath care institution to maintain accuracy and quality of therapeutic treatment delivery. Maintaining a history of the usage of the device is also helpful to justify purchasing additional clinical devices when needed, or where the record indicates that a particular clinical device has become obsolete and needs to be replaced by a newer model of the device.

The care management system 30 also includes a consumable tracking module 180 that maintains a record of all consumable item usage for treatment of each patient. This record ensures that appropriate supplies are ordered and delivered to the nursing unit in a timely and cost-efficient manner to prevent outages of necessary supplies. Such information may also be used by the hospital inventory systems through an appropriate interface or other management system to ensure that the supply purchasing is done as cost-effectively as possible. The consumable tracking module 180 provides on-line queries and report generation summarizing consumable uses for a particular patient, a particular nursing unit, or a variety of other purposes.

The unit management tool module 185 assists nurses in sharing information related to patients and automates routine transactions within the nursing unit. The unit management tool module 185 allows a nurse to record the allergies, handicaps, and special care needs of the patient which, cooperating with the medical administration management module 110 and the clinical monitoring and event history module 115, displays that information prominently on all appropriate display screens, either at the pharmacy video display 64, the nursing video display 74 or at the bedside video display 84 (FIG. 1). The unit management tools module 185 also allows a nurse to record patient transfers and the times when the patient is out of the room or off the floor, such as, for example, when the patient is transferred to surgery or to a different part of the institution for a particular kind of treatment such as rehabilitative therapy. This system may also be programmed to signal an alarm when a patient has been disconnected from the system longer than scheduled, for example, when the patient disconnects from the infusion to attend to personal hygiene. This function ensures that an alarm or alert is sounded and that appropriate personnel are notified of any potential problems and can take the necessary actions to alleviate the alert condition.

The knowledge resource tools module 190 provides a framework for information sharing among the various units in the hospital and also supports an assortment of everyday tools used by the nurses, physicians and technicians involved in the delivery of health care within the institution. This module allows or assists in integrating external information sources into the care system 30 to improve the effectiveness of the care management team in treating the patients in the institution.

For example, the knowledge resource tools module 190 may provide a variety of on-line tools including, for example, a calculator, a dose rate calculator for calculating the appropriate dosage and infusion rate for a particular drug to be infused into a patient, a standard measurement conversion calculator for converting between units of measurement, a skin surface area calculator, and a timer and stopwatch. These resources may be displayed on the video displays 64, 74, 84 at appropriate points within the system, and are available from any CPU either in the pharmacy, at the nursing station or at the bedside. These application tools can be programmed to appear on the video display 64, 74, 84 either automatically, such as, for example, when an infusion pump is configured at the start of an infusion to assist in the calculation of a dose rate. These resources may also be available upon entry of the appropriate command by a nurse, physician or technician.

As depicted in FIG. 2, the care management system 30 is connected to other systems in the institution via an interface 10. This interface may support standard health level 7 (HL7) interfaces to the hospital's other information systems and can also support custom interfaces to systems or devices that do not support the HL7 standard. The system interfaces may be either real-time or batch mode, although a real-time interface to a hospital's pharmacy information system is required to support the on-line medical administration records keeping function of the medical administration management module 110.

The care management system software can be written to operate on a variety of operating systems to suit the needs of a variety of institutions. In a present embodiment, the software is written to interface with the nurses and physicians using the Windows environment (Windows is a trademark of Microsoft, Inc.) on IBM compatible micro-computers. The Windows environment is well-known by those skilled in the art and will not be described in detail herein. The care management system software, when implemented using the Windows system, is particularly useful in that the Windows operating system provides the ability to load several programs at once. Multitasking programs, allowing several application programs to run simultaneously yet providing immediate access to the various software modules of the care management system 30 may also be used.

One particular mode of operation of the present invention will now be described. Most hospitals commonly have an established formulary of medications which defines how the medications are typically dispensed. When a patient care management system according to the present invention is first installed, a hospital committee may be formed to determine how that formulary would be applied to the patient care devices in the institution. The configuration definitions (e.g., by hospital unit such as ICU, NICU, Pediatrics, Oncology, Surgery, etc.) are agreed upon and the drugs and typical infusion protocols and guidelines are established. In addition, all out-of-limit conditions are defined. A technician at the institution may enter these values into the database 122 (FIG. 9), or multiple configuration databases, to customize it for the particular institution. Alternatively, an institution may purchase, or otherwise be provided, with a medical database, containing commonly used rule sets, protocols, out-of-limit events and the like, which may be used by the institution, or which may be modified by the institution as desired.

A patient entering a hospital or other care giving facility is provided with a wristband, necklace, ankle band or other identifier that is affixed to the patient in a manner so that the patient can be identified even if the patient is unconscious or otherwise unresponsive. This wristband or other device may include a bar code representing the name of the patient and other information that the institution has determined is important. Additionally, any other information such as age, allergies, or other vital information may be encoded into the bar code. Alternatively, the patient information device may be an active embedded computer or passive device attached to a wrist band or other carrier that is attached to the patient. Such a device would be responsive to devices located throughout the care-giving facility, such as readers or wireless transmitter/receivers, to provide the identity of the patient along with other information when the device is queried.

After the patient is admitted and situated in a bed within the facility, the patient is typically evaluated by a physician and a course of treatment is prescribed. The physician prescribes a course of treatment by preparing an order which may request a series of laboratory tests or administration of a particular medication to the patient. In some case, the physician prepares the order by filling in a form or writing the order on a slip of paper to be entered into the hospital system for providing care. In other cases, the physician may enter the medication order directly into a physician order entry system 42 (FIG. 1) or may instruct a nurse or other care-giving professional to do so.

If the order is for administration of a particular medication regimen, the order will be transmitted to the facility's pharmacy information system 20. Using the pharmacy CPU 60, the pharmacy reviews the order. The pharmacy management and guidelines module 120 checks each order against the database 122 for incompatibilities, including interactions with other drugs and with patient conditions, such as patient allergies, diseases, and vital signs. If no incompatibilities are detected, the pharmacy prepares the medication according to the requirements of the physician. Typically, the pharmacy packages the medication in a container, and a copy of the order, or at a minimum the patient's name, the drug name, and the appropriate treatment parameters are represented on a label that is affixed to the drug container. This information may be represented by a bar code, or it may be stored in a smart label, such as a label having an embedded computer or passive device.

Once the order has been prepared, the order is sent to the nurse station for matching with the appropriate patient. Alternatively, if the medication is for a commonly or routinely prescribed medication, the medication may be included in an inventory of medications that is stored in a secure cabinet adjacent the nurse station. In such a case, the nurse station will receive from the pharmacy a list of the orders stored in the pharmacy information system 20 that may be drawn from the inventory adjacent the nurse station. The nurse will enter her identifier at the cabinet to gain access, in accordance with standard practice. The nurse or other professional assigned the task of gathering medications will then match the orders received from the pharmacy information system 20 to the medications stored in the inventory and pull those medications that are to be delivered to specific patients. These procedures are carried out whether the medication to be delivered is an oral medication, or a medication that is to be delivered intramuscularly or through an infusion.

After the pharmacy checks, prepares and routes the order, the pharmacy or other central location continues to monitor and manage the subsequent handling of each order at the institution. The medical administration management module 110 provides displays and/or reports for upcoming and on-going administrations for the pharmacy CPU 60. The pharmacy management and guidelines module 120 provides centralized pharmacy control over the medical orders and administrations, permitting the pharmacy to send instructions or updates to nurses regarding the administrations. Module 120 may also require pharmacist approval before a nurse or other care-giver may modify the parameters of a medication order. As discussed previously, in some embodiments, the centralized medication monitoring and management system of the present invention is not associated with a pharmacy. Rather, components of the system may be embodied in any hardware and software that may be associated with network 5. Further, other clinicians, in addition to or instead of a pharmacist, may be involved in monitoring aspects of the system.

The pharmacy management and guidelines module 120 also continues to check each order and the subsequent delivery information against the database 122 (FIG. 9) for incompatibilities or other problems that may have arisen after the order was prepared and/or after the medication delivery has begun. The guidelines module 120 may be run from a central processor, such as the pharmacy CPU 60 (FIG. 1), which has access to the data through network connection 30. If the guidelines module 120 detects any incompatibilities, the pharmacist may be alerted and prompted to make any necessary changes to the medication order. Alternatively, the module 120 may automatically alter the administration parameters of the medical order in accordance with the rule sets 162 or other guidelines. The pharmacist or other clinician may communicate with the care-giver at the point of care regarding the adjustments in the medical orders, such as via a clinical device, a medical transaction carrier such as a PDA or portable computer, or the nurse's station CPU 70.

When the prescribed time for delivery of the medications arrives, the medications are carried to the patient's area and administered to the patient by the nurse or other care-giver. In the case of drugs to be delivered via infusion, the care-giver hangs the infusion bag, attaches the bag to an infusion pump, and sets up the infusion pump to deliver the medication by programming the pump with values for various parameters that are used by the pump to control delivery of the medication to the patient.

For certain drugs, the care-giver is prompted to enter data descriptive of a selected patient parameter or parameters, such a laboratory value or a current vital sign, before completing the verification process. For example, the care-giver may be prompted to measure and enter a value for a patient's blood pressure before administering certain selected drugs. The system may include ranges of acceptable values for the parameters. If the system detects an out-of-range value for the parameter, the system causes an alarm to be provided. In an alternative embodiment, the parameters could be monitored and entered into the system automatically, eliminating the need for manual entry by the care-giver.

Once the medication delivery parameters and any other data is entered into the pump, the data is analyzed by the medical administration management module 110 which records the therapeutic regimen information in the patient's MAR, and verifies that the right medication is being given to the right patient in the right dose by the right route and at the right time. If the medical administration management module 110 detects a discrepancy between the barcoded information printed on the patient bracelet and the barcoded information on the label affixed to the medication container, an alert is sounded and the appropriate information is displayed on the video display 84 attached to the bedside CPU 80. The nurse or technician then either corrects the discrepancy by either re-reading the barcode on the patient's bracelet and the barcode on the medication container or, alternatively, by entering the appropriate information into the bedside CPU 80 using the keyboard 82 or touch screen 83, mouse, or other device. In the event that the nurse or technician determines that the discrepancy cannot be automatically corrected by re-reading the barcodes and that the discrepancy is minor and will not affect the accuracy or safety of the delivery of the medication, the nurse or technician may override the alert. Such action may be subject to approval of the pharmacist through the pharmacy management and guidelines module 120.

In an embodiment of the present invention, where the medication is to be delivered using an infusion pump, such as the infusion pumps 92, 94 attached to the bedside CPU 80 (FIG. 2), the care management system automatically downloads information consisting of the appropriate configuration parameters for the infusion from the pharmacy CPU 60 through the local area network 50 into the bedside CPU 80 and then into the infusion pump 92 when the verification function of the medical administration management module 110 is complete. This is particularly advantageous in that one potential source of inaccuracy is eliminated by automatically configuring the pump, thus eliminating the need for the nurse or technician to manually enter the parameters necessary to configure the infusion pump 92. In one embodiment, the infusion pumps 92 comprise IVAC Corporation Model 570 volumetric pumps. In an embodiment where the pumps cannot be automatically configured by downloading parameters from the network, the care management system 30 only verifies that the right treatment is being administered to the right patient. The pump must then be manually configured by the physician, nurse or technician.

In one embodiment, institutional guidelines for appropriate parameters associated with the entered parameters such as maximum and minimum doses may be stored in the database 122 along with the guidelines relating to drug and patient condition incompatibilities. The pump, or other medication administration device, may also have incorporated within a memory associated with the pump or medication administration device, a database of guidelines for appropriate parameters associated with the entered parameters. In the case where patient care systems or medication administration devices are connected to a hospital server, such a database may also be located at the hospital server and the patient care system or medication administration device would communicate with the server during the verification stage to obtain the acceptable ranges. In another embodiment, the library may be located in a portable data assistant (herein “PDA”) such as a Palm Pilot™ with which the patient care system or medication administration device may communicate via infrared link, RF, blue tooth, or by other means. The nurse or care-giver may carry the PDA and before the patient care system or medication administration device will begin operation, it must communicate with the PDA to compare the hard and soft limits against the entered values.

Once medication administration values have been entered into the patient care system or medication administration device by a nurse or other care-giver, these values are checked against the stored database to verify that the selected values are within acceptable ranges. If a selected value contravenes a hard limit, the processor will alarm and require a value change before operation of the medication administration device can begin. If the selected value contravenes a soft limit, the processor of the medication administration device will require an acknowledgment from the nurse or other care-giver that he or she understands the value entered is outside a soft limit and that this value is nevertheless to remain in force.

Storing a data base of institutional standards for drug infusion parameters and physiological parameter limits, such as the maximum and minimum concentrations of CO₂ and SpO₂ and the maximum and minimum values of respiration rate, also aids in standardizing the quality of care in a clinical setting. In some embodiments, infusion parameter values or physiological parameter limits may be entered automatically from a machine-readable label, for example using a bar code reader mounted on the bag or on the syringe or other medical fluid container in which the medical fluid to be infused is stored. In other embodiments, such infusion parameter values and physiological parameter values may also be entered by other means, such as through a connection with an external processor, such as a hospital server, through connection to a PDA, or other. Connections with these devices may be made in various ways, such as direct, hardwired connection, infrared link, blue tooth link, or others.

The medical database system of one embodiment of the present invention receives medication administration information from a nurse or care-giver prior to medication administration, compares that information to institutionally established guidelines for administration of various medications, and provides an alert if any or all of the medication administration information received from the medication administration device falls outside of the guidelines stored within the medical database. This allows the nurse or care-giver administering the medication to correct the administration parameters entered into the medication administration device before medication administration to the patient is begun. If the administration information falls within the guidelines, the nurse or care-giver may receive a message that medication administration may begin. In one embodiment, the medication administration device may be “locked out”, that is, electronically prevented from beginning administration of the medication until the medication administration device receives a signal from the processor that the administration parameters entered into the administration device are appropriate for the medication and that institutional guidelines for the administration have been met, unlocking the medication administration device and allowing the care-giver to begin medication administration.

Once the infusion pump or other medication administration device is configured, the nurse, caregiver, or technician starts the infusion by pressing the appropriate control on the infusion pump 92. Starting a pump that is capable of being monitored automatically by the care management system causes a signal to be transmitted from the pump to the bedside CPU 80 which is then logged by the clinical monitoring and event history module 115 and entered by the medical administration management module 110 into the patient's MAR. In the case where the institution is using a pump that is not capable of being configured by downloading parameters from the network, the nurse or other caregiver logs the start of the infusion using the touch screen device, mouse or other device connected to the bedside CPU 80. In this case, the video displays of the care management system that display information about the status of the infusion will not display real-time data. Rather, the care management system will project what the status of the infusion should be given the infusion parameters, the time elapsed since the infusion began, and any other events that were manually logged by the caregiver that may have affected the progress of the infusion.

The care management system, utilizing the application modules described above, monitors the infusion process in a real-time manner, providing alerts on the appropriate video display screens located throughout the institution and allows intervention by nurses or other caregivers at remote locations if necessary. In particular, the care management system of the present invention provides centralized monitoring and management by the pharmacy at the institution. For example, the care management system provides a scheduling report to the pharmacy in determining the status of ongoing infusions, as well as in scheduling the preparing of medications for future infusions. The care management system also supports intervention by the pharmacy and can require intervention by other care-givers to be subject to pharmacy approval. A pharmacy guidelines database is also provided to check for incompatibilities, such as those involving other medications or specific patient conditions, associated with medication orders and their subsequent delivery.

In another embodiment, the present invention includes a “Code Mode” that allows a care-giver to bypass the system to immediately cause a list of drugs that have been preselected by the institution to be used in an emergency situation. The initiation of the “Code Mode” causes a time-stamp to be placed in the patient's MAR along with the identity of the drug selected from the displayed list of drugs to be used to treat the emergency. This feature ensures that the emergency and the treatment used to address the emergency are accurately recorded in the patient's MAR.

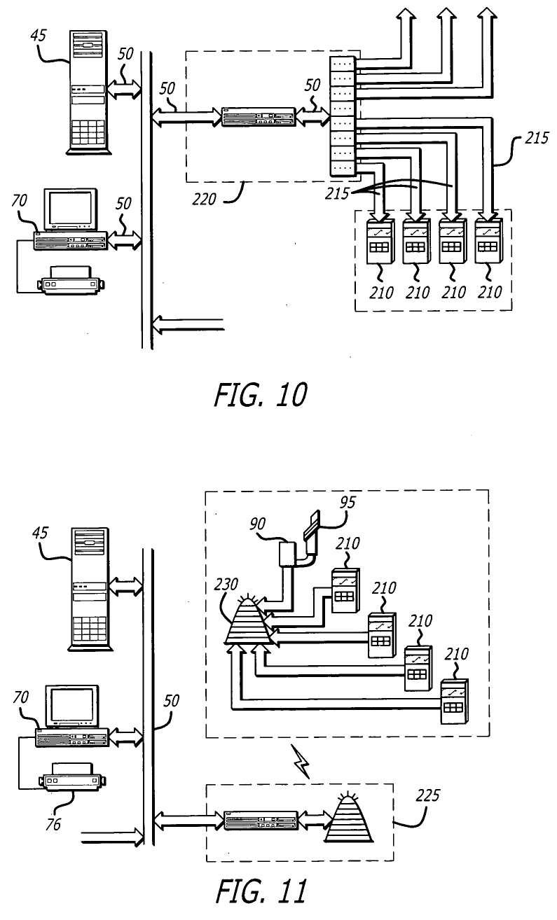

While one particular embodiment of the present invention has been described above, alternative configurations of the care management system network are possible. For example, one alternative embodiment of the care management system is depicted in FIG. 10. In this configuration, clinical devices 210 are connected by means of appropriate interfaces and cabling 215 to a bedside data concentrator 220 which would typically be located outside of a private room, semi-private room or ward area. In this configuration, there is no bedside CPU 80 as described previously. Instead, the bedside data concentrator 220 is connected through an appropriate interface and cabling to the local area network 50, where the data gathered from the clinical devices 210 is then available for processing by the care management system and display at the various monitoring stations, such as either in the pharmacy or at the nurse station 70. In this embodiment, there is no bedside CPU 80 having a keyboard 82 for data entry or a video display 84 for display of either clinical device information or patient information. As described previously, the devices may also communicate with each other and the communication system 50 by wireless means.

A further embodiment of the care management system local area network is depicted in FIG. 11. In this embodiment, the file server and monitoring stations are connected using appropriate interfaces and ethernet cabling to an RF data concentrator 225. At the bedside locations in the private rooms, semi-private rooms or ward areas of the institution, the clinical devices 210 and barcode reader 90 at the bedside are connected to an RF transmitter/receiver 230. This RF transmitter/receiver 230 transmits the information gathered from the clinical devices 210 and the barcode reader 90 to the RF data concentrator 225 attached to the local area network 50. Thus, expensive cabling is not required to connect every patient treatment area. Additionally, flexibility in locating the clinical devices 210 and barcode reader 90 is obtained as well as allowing the ability to reconfigure the patient treatment area without costly rewiring of the ethernet cabling.

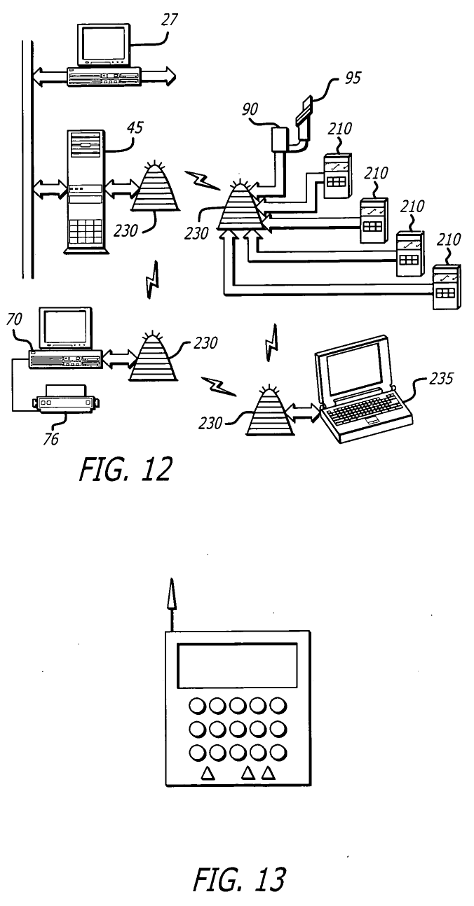

Yet another embodiment of the care management system local area network 50 configuration is shown in FIG. 12. In this configuration, the ethernet cabling connecting the pharmacy CPU, the nurse station nursing CPU 70 and bedside CPUs and clinical devices is eliminated entirely. Each hardware element, comprising the file server, nursing CPU 70, pharmacy CPU 60 and bedside CPUs 80 and clinical devices and/or barcode readers is connected to an RF transmitter/receiver 230. In this manner, all of the information is transmitted throughout the local area network 50 by way of radio transmission rather than by using costly network cabling. Such a system would additionally allow for the use of portable computers 235, PDAs, smart cards and other devices, such as portable medication data carriers, described more fully below, having RF transmitter/receivers 230 or other means of wireless communication, as have been described above, that could then be carried with physicians, nurses or technicians as they circulate through the institution. With this configuration, caregiving personnel could access the care management system either spontaneously or upon notification of an alert no matter where they were in the institution at any given time. Such a system would be particularly useful in a large institution where caregiving personnel are likely to be responsible for many hospital beds or when personnel are out of the area or off the floor. In accordance with aspects of the present invention, a medication database carrier (“MDC”) 300, one embodiment of which is depicted in FIG. 13, including a processor and a memory for storing information is provided to support communication between a nurse and the central pharmacy. The MDC 300 may also be used to document medication delivery of oral, intramuscular (“IM”), subcutaneous, and topical drugs. Further, the MDC 300 may document medical treatments provided by patient care devices that are not connected to the network. The MDC 300 may also enable communication between a care-giver and the centralized medication monitoring system or a clinician affiliated with the centralized medication monitoring system, such as a pharmacist.

In addition, various types of information may be stored in the memory of the MDC 300, including databases containing information about drug interactions and possible contraindications and/or side-effects of medications, and a library or libraries of established guidelines for the administration of various medications.

In one embodiment of the present invention, the MDC 300 may be interfaced to the nurse station computer system 70 (FIG. 2) or any other of the information systems of the central system of an institution through a cradle or other docking device that provides a connection between the MDC 300 and the care management system. This information may then be processed and stored on the care management system, or the information may be communicated by the care management system to various other institutional information systems over the communication system 50. In this manner, information from the pharmacy information system 20, for example, may be communicated through the communication system 50, the nurse station computer system 70, and the MDC cradle into the MDC 300. Similarly, information contained within the MDC 300 may be communicated through the MDC cradle, the nurse station computer system 70, and the communication system 50 to any of the interconnected systems 4, 20, 40, 42 and 49. Alternatively, the MDC may be capable of wireless communication with any or all of the interconnected systems 4, 20, 40, 42 and 49, or any other institutional system.

The MDC 300 typically will also be capable of retrieving medication administration parameters or information from a medication administration device, and storing data or information concerning various transactions in its memory representing the identity and treatment regimens for medications given to a patient, as well as other information, such as care-giver identity, equipment location, patient vital signs information, or any other information sought to be recorded. The MDC 300 may also store data or information concerning primary or secondary validation of previous and/or duplicate transactions of medical treatment information. The display of the MDC may also provide a care-giver with messages or other information, such as warnings or prompts to enter data, related to medication administration. Moreover, the keyboard or other information entry means of the MDC may be used for manually entering information into the MDC for storage in the memory of the MDC.

A particularly advantageous embodiment includes storing information about the medication administration, such as the medication administration or treatment parameters, and/or other information, such as the identity of the patient and care-giver, in the memory of the MDC 300 until the MDC 300 re-establishes a communication connection with the care management system, whereby the information stored in the memory of the MDC 300 may be communicated to the care management system and incorporated into one or more of an institution's information databases, thus being made available to the pharmacy management and guidelines module 120. Updating the databases provides a verification that the treatment has been rendered thereby avoiding a duplicate treatment. In this manner, the present invention “closes the loop” ensuring that the right medication has been given in the right manner to the right patient.

For example, consistent with the present invention, the MDC 300 may be embodied in a hand-held “personal digital assistant” (“PDA”) such as a Palm™ Pilot or any PDA running either the Palm™ operating system or the Windows™ operating system, a desktop computer, a notebook computer, or other portable computer system. The MDC may also comprise a smartcard such as those that are capable of processing and storing data, such as the American Express Bluecard. The use of such devices is advantageous in that devices having a suitably large memory to accommodate the type of information required by the present invention to monitor and track medication administration information and validate treatment as well as retrieving other patient information, are readily available and relatively inexpensive, thus allowing an MDC to be assigned to each individual patient, or alternatively, to an individual medication administration device, such as an infusion pump, or other clinical device, such as a vital signs monitor. Additionally, such devices are small, compact and easily transportable.

Alternatively, the MDC 300 may be embodied in any device that includes an active embedded processor and a memory capable of storing information. Such an active embedded processor may be even smaller and more portable than a PDA or notebook computer. For the purposes of the present invention, such an active embedded processor includes any device incorporating a microprocessor and allows for input and/or output of information, whether via electrical, radio frequency, or optical means, wireless or direct contact, and which contains its own power supply. One example of an active embedded processor in accordance with this invention may be attached to or embedded in the packing or container of a medication to be delivered to a patient. Such devices may typically be manufactured no larger than, for example, a postage stamp or business card and yet include, using micro circuitry, enough processing power, information storage, data or information input and output, and power to be suitable for use as a medical database carrier. Alternatively, the embedded processor and memory may be integrated into a medication administration device, such as an infusion pump or other device.

Furthermore, the institutional communication systems 5 and 50 as mentioned above numerous times are not meant to be taken in a limited sense. Such a communication system may encompass an entire hospital facility or may be located only in a small area of the hospital. It may also include a communication system in a care-giving facility other than a hospital and may have application to an alternate care facility, such as a patient's home. The above embodiments are described for exemplary purposes only.

In the above detailed description, well-known devices, methods, procedures, and individual components have not been described in detail so as not to obscure aspects of the present invention. Those skilled in the art will understand those devices, methods, procedures, and individual components without further details being provided here. Moreover, while the embodiments disclosed above are described for use in a hospital environment, it will be understood that the system and method may be useful in other environments as well, such as outpatient clinics and other environments where care is delivered to a patient.

While several specific embodiments of the invention have been illustrated and described, it will be apparent that various modifications can be made without departing from the spirit and scope of the invention. Accordingly, it is not intended that the invention be limited, except as by the appended claims.

1. A patient care system, comprising:
a plurality of medication administration devices for delivering medication to a plurality of patients;
a memory associated with each medication administration device for storing medication administration information associated with the medication delivered to each patient, the medication administration information including a plurality of medication administration parameters and a parameter value associated with each medication administration parameter;
a central processor configured to receive medication administration information from each of the medication administration devices;
a database operatively connected to the central processor for storing medication administration guidelines representing acceptable values for the medication administration parameters; and
means for communicating medication administration information from each of the medication administration devices to the central processor;
wherein the central processor is further configured to compare the parameter values to the acceptable values for the parameters in the medication administration guidelines.

2. The patient care system of claim 1, further comprising a central computer display operatively connected to the central processor and wherein the central processor is further configured to display the medication administration information on the central computer display.

3. The patient care system of claim 2, wherein the central processor is further configured to provide a visual indication on the central computer display if one of the parameter values does not fall within the acceptable values for the parameter in the corresponding medication administration guideline.

4. The patient care system of claim 2, wherein the central computer display is located in a pharmacy.

5. The patient care system of claim 3, further comprising:
means for a clinician to adjust the medication administration parameter values in response to the visual indication.

6. The patient care system of claim 5, further comprising:
means for the clinician to report to a caregiver at the point of care the adjusted medication administration parameter values.

7. The patient care system of claim 1, wherein the central processor is further configured to automatically adjust the medication administration parameter values in response to an indication that one of the parameter values does not fall within the acceptable values for the parameter in the corresponding medication administration guideline.

8. The patient care system of claim 1, wherein the central processor periodically compares the parameter values to the acceptable values for the parameters in the medication administration guidelines throughout the administration of the medication.

9. The patient care system of claim 2, further comprising:
means for communication between a caregiver located at one of the medication administration devices and a clinician located at the central computer display.

10. The patient care system of claim 1, wherein the medication administration parameters include current medication administration device operating parameters.

11. The patient care system of claim 1, wherein the medication administration guidelines include the acceptable values for the medication administration parameters based on patient condition data.

12. The patient care system of claim 11, further comprising:
a memory operatively connected to the central processor for storing patient condition data associated with each patient;
wherein the processor is further configured to compare the parameter values to the acceptable values for the parameters in the medication administration guidelines corresponding to the stored patient condition data associated with each patient.

13. The patient care system of claim 12, wherein the patient condition data for each patient includes current physiological status.

14. The patient care system of claim 1, wherein the medication administration guidelines include the acceptable values for the medication administration parameters based on medication indication data.

15. The patient care system of claim 1, further comprising:
a memory in which is stored medication order information for a plurality of patients, the medication order information including a plurality of prescribed medication administration parameters for delivering medication to each patient and a parameter value associated with each prescribed medication administration parameter; and
wherein the processor is further configured to compare the parameter values of the prescribed medication administration parameters to the acceptable values for the medication administration parameters in the medication administration guidelines.

16. The patient care system of claim 15, further comprising a central computer display operatively connected to the central processor and wherein the central processor is further configured to display the medication order information and the medication administration information on the central computer display.

17. A method for centralized monitoring of medication administration for a plurality of patients, comprising:
monitoring medication administration information associated with medication delivered to each patient, the medication administration information including a plurality of medication administration parameters and a parameter value associated with each medication administration parameter;
storing a database of medication administration guidelines representing acceptable values for the medication administration parameters;
communicating the medication administration information and the medication administration guidelines to a central location;
comparing the parameter values to the acceptable values for the parameters in the medication administration guidelines; and
providing an indication at the central location if one of the parameter values does not fall within the acceptable values for the parameter in the corresponding medication administration guideline.

18. The method of claim 17, further comprising:
displaying the medication administration information on a computer display at the central location.

19. The method of claim 18, wherein providing an indication at the central location includes displaying an alert on the computer display.

20. The method of claim 17, further comprising:
adjusting the medication administration parameter values from the central location in response to the indication.

21. The method of claim 17, further comprising:
communicating information from the central location to a care-giver located at the point of care.

22. The method of claim 17, further comprising:
periodically comparing the parameter values to the acceptable values for the parameters in the medication administration guidelines throughout the administration.

23. The method of claim 17, wherein the medication administration guidelines include the acceptable values for the medication administration parameters based on patient condition data.

24. The method of claim 17, wherein the medication administration guidelines include the acceptable values for the medication administration parameters based on medication indication data.
